(19) United States
(12) Patent Application Publication
(10) Pub. No.: US 2014/0304027 A1
(43) Pub. Date: Oct. 9, 2014

(54) METHODS AND SYSTEMS FOR WORKFLOW CLUSTER PROFILE GENERATION AND SEARCH

(71) Applicant: XEROX CORPORATION, NORWALK, CT (US)

(72) Inventors: Changjun Wu, Webster, NY (US); Hua Liu, Fairport, NY (US); Frank Goetz, Fairport, NY (US); Arun Bakthavachalu, Webster, NY (US)

(73) Assignee: XEROX CORPORATION, NORWALK, CT (US)

(21) Appl. No.: 13/857,648

(22) Filed: Apr. 5, 2013

(51) Int. Cl. G06Q 10/06

(52) U.S. Cl. CPC G06Q 10/0633
USPC 705/7.27

(57) ABSTRACT

A system and method for generating and searching workflow cluster profiles by generating a workflow similarity graph based on multiple workflows, generating a set of workflow clusters based on the workflow similarity graph, generating workflow cluster profiles for the set of workflow clusters, receiving a querying workflow, and comparing the querying workflow to the workflow cluster profiles.

### TECHNICAL FIELD

The present disclosure relates generally to methods, systems, and computer-readable media for generating and searching workflow cluster profiles.

### BACKGROUND

A workflow is a representation of a sequence of connected steps that is useful in various industries and for various purposes to describe efficient ways of performing tasks, to ensure that all required steps are performed, to effectively partition work, etc.

In certain situations a user may want to compare a first workflow, such as a workflow currently used by a company, to other similar workflows to determine, for example, if a more efficient workflow can be utilized. However, comparing the workflow to a large database of workflows to find similar workflows using a standard linear search can be time consuming and/or require a large amount of processing capabilities.

Therefore, workflow technologies can be improved by methods and systems for efficiently searching and comparing workflows.

### SUMMARY

The present disclosure relates generally to methods, systems, and computer readable media for providing these and other improvements to workflow technologies.

In some embodiments, a computing device can generate a workflow similarity graph from a set of workflows. The workflow similarity graph can connect workflows when a comparison of the workflows produces a similarity score above a threshold. Based on the workflow similarity graph, the computing device can generate a set of workflow clusters, where a cluster includes multiple workflows. Based on the set of workflow clusters, the computing device can generate a workflow cluster profile for each workflow cluster.

In further embodiments, a user can submit a querying workflow to receive a cluster of workflows that is similar to the querying workflow. The computing device can compare the querying workflow to each workflow cluster profile to determine a workflow cluster profile that represents a cluster of workflows that is similar to the querying workflow.

### BRIEF DESCRIPTION OF THE DRAWINGS

The accompanying drawings, which are incorporated in and constitute a part of this specification, illustrate various embodiments of the present disclosure and together, with the description, serve to explain the principles of the present disclosure. In the drawings:

FIG. 1 is a flow diagraming illustrating an exemplary method of generating and searching workflow cluster profiles, consistent with certain disclosed embodiments;

FIG. 2A is a diagram depicting exemplary workflows in an exemplary cluster, consistent with certain disclosed embodiments;

FIG. 2B is a diagram depicting exemplary identified components of the exemplary workflows, consistent with certain disclosed embodiments;

FIG. 2C is a diagram depicting an exemplary workflow cluster profile generated from the exemplary workflow cluster, consistent with certain disclosed embodiments; and

FIG. 3 is a diagram depicting an exemplary computing device capable of utilizing workflow technologies, consistent with certain disclosed embodiments.

### DETAILED DESCRIPTION

The following detailed description refers to the accompanying drawings. Wherever possible, the same reference numbers are used in the drawings and the following description refers to the same or similar parts. While several exemplary embodiments and features of the present disclosure are described herein, modifications, adaptations, and other implementations are possible, without departing from the spirit and scope of the present disclosure. Accordingly, the following detailed description does not limit the present disclosure. Instead, the proper scope of the disclosure is defined by the appended claims.

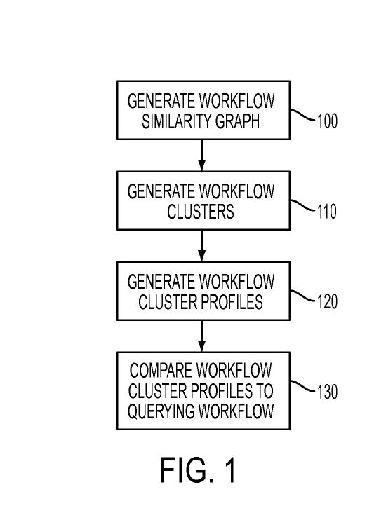

FIG. 1 is a flow diagraming illustrating an exemplary method of generating and searching workflow cluster profiles, consistent with certain disclosed embodiments. As used herein, a workflow can refer to any representation of a sequence of connected steps that can be performed by a person, a group of persons, an organization, one or more machines, one or more computing devices, etc.

The process can being in 100 when a computing device generates a workflow similarity graph based on a set of workflows. For example, the computing device can generate the workflow similarity graph by performing a pair-wise comparison of each workflow pair in the set and determine that a pair of workflows are similar if the similarity score from the pair-wise comparison meets or exceeds a set threshold. If a pair of workflows are determined to be similar, the workflows can be connected in the workflow similarity graph (e.g. an edge can be drawn between two vertices representing the two workflows).

In some embodiments, the workflow similarity graph can be non-directional and/or non-weighted. Accordingly, if a pair of workflows generate a similarity score above a threshold, the workflows can be connected in the workflow similarity graph with no direction and no weight or value assigned to the connection.

As an additional example, the workflow similarity graph can be generated by first decomposing the workflows into components and identifying shared components between workflows, as described in [20120703], which is incorporated herein in its entirety. As used herein, a decomposed segment of a workflow can be referred to as a “component,” and a component can include one or more steps of the workflow.

In 110, the computing device can generate a set of workflow clusters using the workflow similarity graph generated in 100. A workflow from the workflow similarity graph can be grouped with other workflows in a workflow cluster in such a manner that workflows in the same cluster are more similar to each other than to those of other workflow clusters. In some embodiments, each workflow from the workflow similarity graph can be grouped into a cluster. The computing device can utilize one or more clustering algorithms know in the art, such as, but not limited to: k-means algorithm, hierarchical clustering, and shingling.

For example, a shingling clustering algorithm can be utilized on the workflow similarity graph to determine if workflows connected (i.e. neighbors) to two selected workflows (i.e. vertices) have a high overlap in connected workflows. The shingling algorithm can use a sampling technique to extract k neighbors (i.e. shingles) from the selected workflows, where k is relatively small value. Accordingly, the probability that the k neighbors are equal for the selected workflows is the same as the overlap rate of connected workflows of the selected workflows. Based on the overlap rate, the singling algorithm can determine whether the selected workflows can be in the same cluster. The higher the overlap rate, the more likely that the selected workflows belong to the same cluster.

In some embodiments, a second level of shingling can be performed by extracting k neighbors of the neighbors from the selected workflows and determining the probability that the neighbors of the neighbors are equal to calculate the overlap rate of the neighbors. All vertices which are connected by shingles can then be joined to create the workflow clusters.

In 120, the computing device can generate a workflow cluster profile for the workflow clusters. In some embodiments, the computing device can generate a workflow cluster profile for each workflow cluster, and each workflow cluster can include at least one workflow.

In embodiments, a seeding based approach can be used generate the workflow cluster profiles for each workflow cluster. For example, when performing the pair-wise workflow similarity comparison, the workflows can be decomposed into basic components (e.g. split, merge, and path components), and after finding the optimal alignment between two workflows, the alignments of the components that yields the maximal similarity score can be tracked. Accordingly, a workflow cluster profile can be generated based on the similarities between shared components.

Further, for a cluster of similar workflows, certain components may be shared by a majority of the similar workflows. Accordingly, these shared components can be extracted from the workflow as part of the workflow cluster profile. Additionally, in some cases, a certain step belonging to similar components might be different in the individual workflows. However, the similar components can still be identified as matching, and an undefined step can be substituted for the inconsistent step. An example workflow cluster profile is explained in detail below.

Accordingly, the workflow cluster profiles can characterize the similarities shared among the workflows in the same workflow cluster. Discrepancies between similar workflows can be accounted for in the workflow cluster profile and can be not considered as different when comparing the workflow cluster profile to querying workflows.

In 130, the computing device can receive a querying workflow and determine a workflow cluster profile that is similar to the querying workflow. In embodiments, the computing device can perform a pair-wise comparison of the querying workflow to each workflow cluster profile and determine the workflow cluster profile that generates the highest similarity score. After the workflow cluster profile with the highest similarity score is determined, the workflow cluster associated with the workflow cluster profile can be transmitted to a requesting device, displayed for a user, etc.

In certain embodiments, the querying workflow can be a complete workflow. As used herein, a complete workflow includes a starting step, an ending step, and a continuous path from the starting step to the ending step. In other embodiments, the querying workflow can be an incomplete workflow. An incomplete workflow can, for example, not include a starting step, not include an ending step, not have a continuous path from the starting step to the ending step, can include isolated steps, can include isolated components, etc.

Additionally, in some embodiments, the workflow cluster profiles can be treated as complete workflows.

Additionally or alternatively, the computing device can perform a pair-wise comparison of the querying workflow and workflow cluster profiles using the methods disclosed in [20111161] and [20121018], which are incorporated herein in their entirety.

While the steps depicted in FIG. 1 have been described as performed in a particular order, the order described is merely exemplary, and various different sequences of steps can be performed, consistent with certain disclosed embodiments. Additional variations of steps can be utilized, consistent with certain disclosed embodiments. Further, the steps described are not intended to be exhaustive or absolute, and various steps can be inserted or removed.

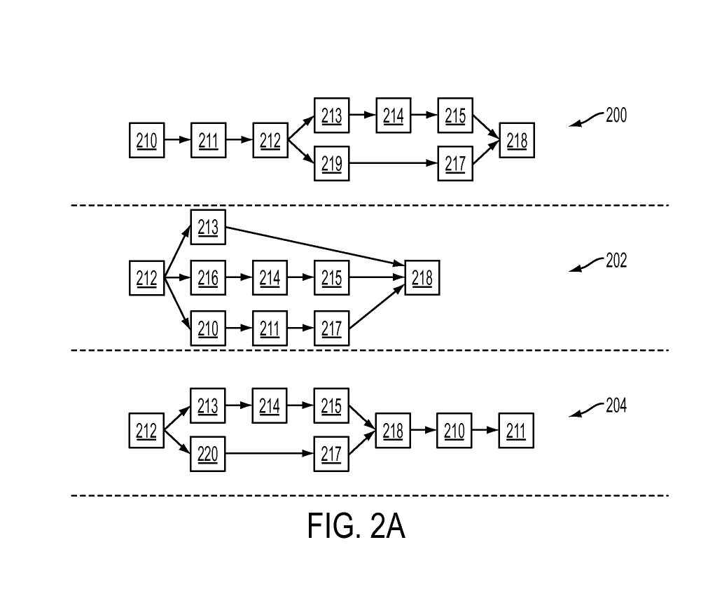

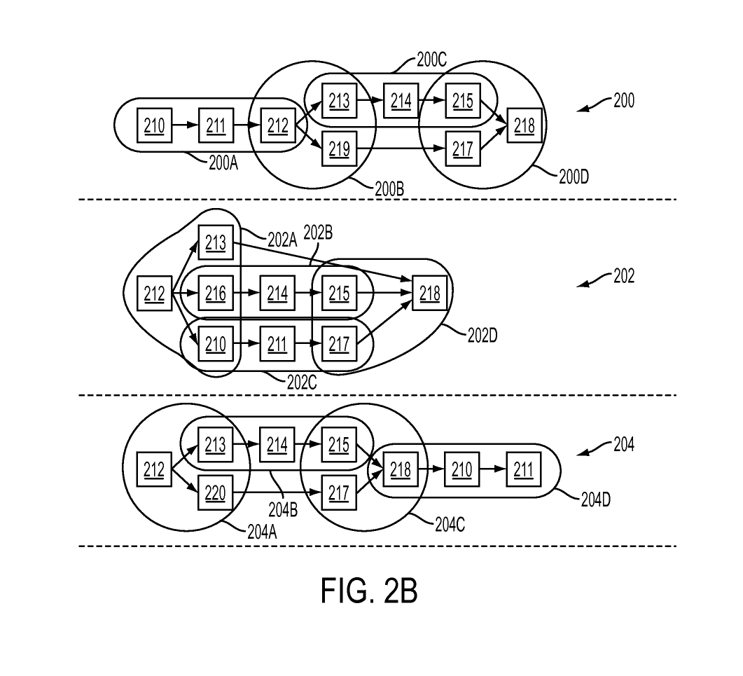

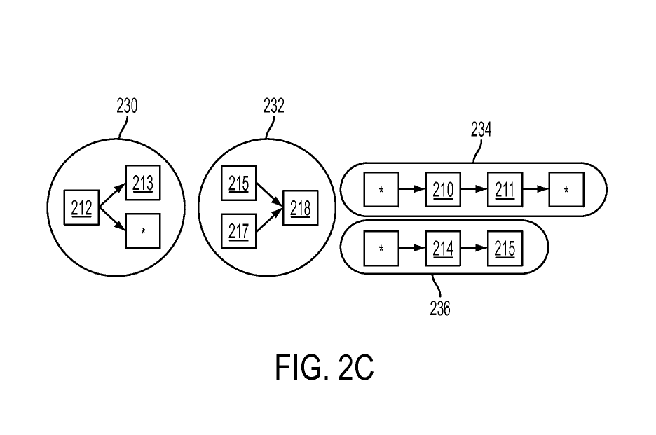

FIG. 2A is a diagram depicting exemplary workflows in an exemplary cluster, consistent with certain disclosed embodiments. FIG. 2A is intended merely for the purpose of illustrating workflows and is not intended to be limiting.

As depicted in FIG. 2A, workflow 200, workflow 202, and workflow 204 can belong to a single workflow cluster. For example, workflow 200, workflow 202, and workflow 204 may have been assigned to a single workflow cluster in 110 from FIG. 1. The workflow cluster depicted in FIG. 2A is an example workflow cluster that can be created and utilized by the technologies described herein. The workflow cluster depicted in FIG. 1 is not intended to be limiting, and a workflow cluster can include more or less workflows, consistent with certain disclosed embodiments.

Workflow 200 is an example workflow that can be utilized by the technologies described herein. Workflow 200 is not intended to be limiting, and a workflow can include more or less steps in various different sequences, consistent with certain disclosed embodiments.

Workflow 200 can start with step 210, followed by step 211 and then step 212. After step 212, workflow 200 can split and can be followed by step 213 and step 219. Step 213 can be followed by step 214 and then step 215, and step 219 can be followed by step 217. Step 215 and step 217 can join into step 218.

Accordingly, workflow 200 indicates that step 210 should be performed before step 211, and step 211 should be performed before step 212. The split into the paths starting with step 213 and step 219, respectively, indicates that step 213 and step 219 can be performed in any order or concurrently. Step 213 should be performed before step 214, and step 214 should be performed before step 215. Step 219 should be performed before step 217. Step 213, step 214, and step 215 can be performed before, after, or concurrently with step 219 and step 217. However, step 215 and step 217 should be performed before step 218.

Workflow 202 is an example workflow that can be utilized by technologies described herein. Workflow 202 is not intended to be limiting, and a workflow can include more or less steps in various different sequences, consistent with certain disclosed embodiments.

Workflow 202 can start with step 212, after which workflow 202 can split and step 212 can be followed by step 213, step 216, and step 210. Step 216 can be followed by step 214 and then step 215. Step 210 can be followed by step 211 and step 217. Step 213, step 215, and step 217 can join into step 218.

Accordingly, workflow 202 indicates that the 212 should be performed before step 213, step 216, and step 210. The split into the paths starting with step 213, step 216, and step 210, respectively, indicates that step 213, step 216, and step 210 can be performed in any order or concurrently. Step 216 should be performed before step 214 and step 214 performed before 215. Step 210 should be performed before step 211 and step 211 should be performed before step 217. Step 213 can be performed before, after, or concurrently with step 216, step 214, and step 214 and before, after, or concurrently with step 210, step 211, and step 217. However, step 213, step 215, and step 217 should be performed before step 218.

Workflow 204 is an example workflow that can be utilized by technologies described herein. Workflow 204 is not intended to be limiting, and a workflow can include more or less steps in various different sequences, consistent with certain disclosed embodiments.

Workflow 204 can start with step 212, after which workflow 202 can split and can be followed by step 213 and step 220. Step 213 can be followed by step 214 and then step 215. Step 220 can be followed by step 217. Step 215 and step 217 can join into step 218. Step 218 can be followed by step 210 and then step 211.

Accordingly, workflow 204 indicates that 212 should be performed before step 213 and step 220. The split into the paths starting with step 213 and step 220, respectively, indicates that step 213 and step 220 can be performed in any order or concurrently. Step 213 should be performed before step 214 and step 214 should be performed before step 215. Step 220 should be performed before 217. Step 213, step 214, and step 215 can be performed before, after, or concurrently with step 220 and step 217. However, step 215 and step 217 should be performed before step 218. Step 218 should be followed by step 210 and step 210 should be followed by step 211.

FIG. 2B is a diagram depicting exemplary identified components of the exemplary workflows, consistent with certain disclosed embodiments. FIG. 2B is intended merely for the purpose of illustrating workflow components and is not intended to be limiting

As depicted in FIG. 2B, component 200A, component 200B, component 200C, and component 200D can represent identified components of workflow 200. For example, components 200A-200D can represent the components identified when, in some embodiments, workflow 200 is decomposed into components to identify shared components with other workflows to generate a workflow similarity graph, as described above.

Additionally, component 202A, component 202B, component 202C, and component 202D can represent identified components of workflow 202. Further, component 204A, component 204B, component 204C, and component 204D can represent identified components of workflow 204.

The identified components for workflow 200, workflow 202, and workflow 204 in FIG. 2B are merely examples of components that can be identified in workflows. In further embodiments, more or less components may be identified in workflows, and the components can include different patterns of steps, different numbers of steps, etc.

FIG. 2C is a diagram depicting an exemplary workflow cluster profile generated from the exemplary workflow cluster, consistent with certain disclosed embodiments. FIG. 2C is intended merely for the purpose of illustrating workflow cluster profiles and is not intended to be limiting. Additionally, FIG. 2C can represent a result of 120 in FIG. 1.

Depicted in FIG. 2C is a workflow cluster profile that can be created by a computing device based on the workflow cluster in FIG. 2A and FIG. 2B. The workflow cluster profile depicted in FIG. 2C is an example workflow cluster profile and is not intended to be limiting.

Profile component 230 can start with step 212 and can then split into step 213 and an additional undefined step. Profile component 230 can be generated based on component 200B, component 202A, and component 204A from workflow 200, workflow 202, and workflow 204, respectively. A computing device can determine that workflow 200, workflow 202, and workflow 204 all include a matching step (step 212) that splits into at least two other steps, one of which is another matching step (step 213). Accordingly, the computing device can generate profile component 230 for the workflow cluster profile for the workflow cluster represented in FIG. 2A and FIG. 2B. Additionally, the profile component identified by the asterisk can be undefined because the workflows do not use matching steps in its place.

Profile component 232 can start with step 215 and 217 that join into step 218. Profile component 232 can be generated based on component 200D, component 202D, and component 204C from workflow 200, workflow 202, and workflow 204, respectively. A computing device can determine that workflow 200, workflow 202, and workflow 204 all include matching steps (step 215 and step 217) that join into another matching step (step 218). Accordingly, the computing device can generate profile component 232 for the workflow cluster profile for the workflow cluster represented in FIG. 2A and FIG. 2B.

Profile component 234 can start with an undefined step followed by step 210, then step 211 and finally another undefined step. Profile component 234 can be generated based on component 200A, component 202C, and component 204D from workflow 200, workflow 202, and workflow 204, respectively. A computing device can determine that workflow 200, workflow 202, and workflow 204 all include a matching step (step 210) followed by another matching step (step 211). Accordingly, the computing device can generate profile component 234 for the workflow cluster profile for the workflow cluster represented in FIG. 2A and FIG. 2B. Additionally, the computing device can determine that in the majority of the workflows, step 210 follows a non-matching step, and can start profile component 234 with an unidentified step. Additionally, the computing device can determine that in all the workflows step 211 is followed by a non-matching step, and can end component 234 with an undefined step.

Profile component 236 can start with an undefined step followed by step 214 and then step 215. Profile component 236 can be generated based on component 200C, component 202B, and component 204B from workflow 200, workflow 202, and workflow 204, respectively. A computing device can determine that workflow 200, workflow 202, and workflow 204 all include a matching step (step 214) followed by another matching step (step 215). Accordingly, the computing device can generate profile component 236 for the workflow cluster profile for the workflow cluster represented in FIG. 2A and FIG. 2B. Additionally, the computing device can determine that in all the workflows, step 214 follows a non-matching step and can start component 236 with an undefined step.

Accordingly, if a user attempts to find workflows that are similar to a submitted querying workflow (130 in FIG. 1), a computing device would not need to compare the querying workflow to every workflow in a database, but, instead, can compare the querying workflow to workflow cluster profiles. Therefore, the number of comparisons can be significantly reduced, allowing for reduced processing time and/or requiring less processing capabilities.

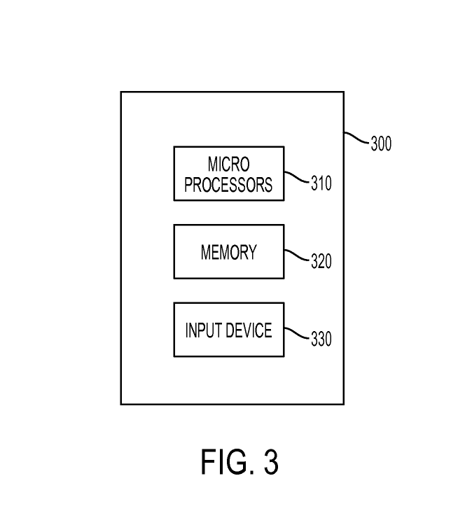

FIG. 3 is a diagram depicting an exemplary computing device capable of utilizing workflow technologies, consistent with certain disclosed embodiments. Computing device 300 may represent any type of one or more computing devices.

Computing device 300 may include, for example, one or more microprocessors 310 of varying core configurations and clock frequencies; one or more memory devices or computer-readable media 320 of varying physical dimensions and storage capacities, such as flash drives, hard drives, random access memory, etc., for storing data, such as images, files, and program instructions for execution by one or more microprocessors 310; one or more transmitters for communicating over network protocols, such as Ethernet, code divisional multiple access (CDMA), time division multiple access (TDMA); etc. One or more microprocessors 310 and one or more memory devices or computer-readable media 320 may be part of a single device as disclosed in FIG. 3 or may be contained within multiple devices. Those skilled in the art will appreciate that the above-described componentry is exemplary only, as computing device 300 may comprise any type of hardware componentry, including any necessary accompanying firmware or software, for performing the disclosed embodiments. Further, computing device 400 can include, for example, input device 330. Input device 330 can include any type of one or more input devices, such as a mouse, a keyboard, a touchscreen, etc.

The foregoing description of the present disclosure, along with its associated embodiments, has been presented for purposes of illustration only. It is not exhaustive and does not limit the present disclosure to the precise form disclosed. Those skilled in the art will appreciate from the foregoing description that modifications and variations are possible in light of the above teachings or may be acquired from practicing the disclosed embodiments. The steps described need not be performed in the same sequence discussed or with the same degree of separation. Likewise, various steps may be omitted, repeated, or combined, as necessary, to achieve the same or similar objectives or enhancements. Accordingly, the present disclosure is not limited to the above-described embodiments, but instead is defined by the appended claims in light of their full scope of equivalents.

What is claimed is:

1. A method of generating workflow cluster profiles, the method comprising:
generating a workflow similarity graph based on a plurality of workflows;
generating a set of workflow clusters based on the workflow similarity graph; and
generating, using one or more processors, a first workflow cluster profile of a set of workflow cluster profiles for a workflow cluster of the set of workflow clusters.

2. The method of claim 1, further comprising:
receiving a querying workflow; and
comparing the querying workflow to the first workflow cluster profile.

3. The method of claim 1, wherein the set of workflow cluster profiles comprises workflow cluster profiles generated for each workflow cluster of the set of workflow clusters.

4. The method of claim 2, wherein:
the set of workflow cluster profiles comprises workflow cluster profiles generated for each workflow cluster of the set of workflow clusters; and
the querying workflow is compared to each workflow cluster profile of the set of workflow cluster profiles.

5. The method of claim 4, further comprising determining a selected workflow cluster profile of the set of workflow cluster profiles that generates a highest similarity score when compared to the querying workflow.

6. The method of claim 5, further comprising, displaying an indication of a selected workflow cluster, wherein the selected workflow cluster profile was generated based on the selected workflow cluster.

7. The method of claim 2, wherein the querying workflow is a complete workflow.

8. The method of claim 2, wherein the querying workflow is a partial workflow.

9. The method of claim 1, wherein generating a workflow similarity graph based on the plurality of workflows comprises:
decomposing each workflow of the plurality of workflows into a plurality components; and
identifying shared components between workflows of the plurality of workflows.

10. The method of claim 9, wherein generating a first workflow cluster profile of a set of workflow cluster profiles for a workflow cluster of the set of workflow clusters comprises generating the first workflow cluster profile based on the plurality of components from each workflow in the first workflow cluster profile.

11. A system for generating workflow cluster profiles comprising:
a processing system comprising one or more processors; and
a memory system comprising one or more computer-readable media, wherein the one or more computer-readable media contain instructions that, when executed by the processing system, cause the processing system to perform operations comprising:
generating a workflow similarity graph based on a plurality of workflows;
generating a set of workflow clusters based on the workflow similarity graph; and
generating a first workflow cluster profile of a set of workflow cluster profiles for a workflow cluster of the set of workflow clusters.

12. The system of claim 11, wherein the processing system further performs operations comprising:
receiving a querying workflow; and
comparing the querying workflow to the first workflow cluster profile.

13. The system of claim 11, wherein the set of workflow cluster profiles comprises workflow cluster profiles generated for each workflow cluster of the set of workflow clusters.

14. The system of claim 12, wherein:
the set of workflow cluster profiles comprises workflow cluster profiles generated for each workflow cluster of the set of workflow clusters; and
the querying workflow is compared to each workflow cluster profile of the set of workflow cluster profiles.

15. The system of claim 14, wherein the processing system further performs operations comprising determining a selected workflow cluster profile of the set of workflow cluster profiles that generates a highest similarity score when compared to the querying workflow.

16. The system of claim 15, wherein the processing system further performs operations comprising, displaying an indication of a selected workflow cluster, wherein the selected workflow cluster profile was generated based on the selected workflow cluster.

17. The system of claim 12, wherein the querying workflow is a complete workflow.

18. The system of claim 12, wherein the querying workflow is a partial workflow.

19. The system of claim 11, wherein generating a workflow similarity graph based on the plurality of workflows comprises:
decomposing each workflow of the plurality of workflows into a plurality components; and
identifying shared components between workflows of the plurality of workflows.

20. The system of claim 19, wherein generating a first workflow cluster profile of a set of workflow cluster profiles for a workflow cluster of the set of workflow clusters comprises generating the first workflow cluster profile based on the plurality of components from each workflow in the first workflow cluster profile.
